(19) United States
(12) Patent Application Publication
(10) Pub. No.: US 2013/0187964 A1
(43) Pub. Date: Jul. 25, 2013

(54) METHOD OF IMPROVING ADHESIVENESS OF MARKING MATERIAL AND RECEIVING MEDIUM AND A PRINTER

(71) Applicant: OCE TECHNOLOGIES B.V., Venlo (NL)

(72) Inventors: Koen Joan KLEIN KOERKAMP, Venlo (NL); Mark MIEDEMA, Velden (NL)

(73) Assignee: OCE TECHNOLOGIES B.V., Venlo (NL)

(21) Appl. No.: 13/791,270

(22) Filed: Mar. 8, 2013

Related U.S. Application Data
(63) Continuation of application No. PCT/EP2011/066838, filed on Sep. 28, 2011.

(30) Foreign Application Priority Data
Oct. 7, 2010 (EP) 10186835.4

(51) Int. Cl. B41J 2/01

(52) U.S. Cl. CPC B41J 2/01
USPC 347/9

(57) ABSTRACT

A method for printing an image by a reproduction apparatus includes a print head with print elements for ejecting marking material on a receiving medium in a multi-pass mode. The method includes selecting a multi-pass mode out of at least two multi-pass modes, dividing the image into a plurality of strips, determining for each strip a total amount of marking material required to print the strip on the receiving medium, ejecting for each strip a first amount of the total amount of marking material on the receiving medium during a first pass, and ejecting for each strip a remaining amount of the total amount of marking material on the receiving medium during passes subsequent to the first pass. A ratio of the first amount and the total amount of each strip is the same for the at least two multi-pass modes. The method is suitable for implementation in a reproduction apparatus.

### CROSS-REFERENCE TO RELATED APPLICATIONS

This application is a Continuation of International Application No. PCT/EP2011/066838, filed on Sep. 28, 2011, and for which priority is claimed under 35 U.S.C. §120, and which claims priority under 35 U.S.C. §119 to Application No. 10186835.4, filed in Europe on Oct. 7, 2010. The entirety of each of the above-identified applications is expressly incorporated herein by reference.

### BACKGROUND OF THE INVENTION

1. Field of the Invention

The present invention relates to a method for printing an image by a reproduction apparatus comprising a print head comprising print elements for ejecting marking material on a receiving medium in a multi-pass mode, the method comprising the steps of dividing the image into a plurality of strips, each strip requiring a total amount of marking material to be ejected on the receiving medium, ejecting for each strip a first amount of the total amount of marking material on the receiving medium during a first pass, and ejecting for each strip a remaining amount of the total amount of marking material on the receiving medium during passes subsequent to the first pass.

The present invention also relates to a reproduction apparatus that is able to apply the methods according to the present invention.

2. Background of the Invention

Reproduction apparatuses are known, which are able to print an image on a receiving medium and comprise a processor unit for controlling the print process and a print engine for actually printing a marking material on the receiving medium.

Printing of the image may be done in passes. A pass is a movement of the print head in one direction across the receiving medium. Usually, after a first pass, the receiving medium is moved relatively to the print head in a direction perpendicular to the one direction. This movement may also be called a paper step. After the paper step, during a second pass after a first pass in one direction, the print head is moving in the opposite direction. An area of the receiving medium, on which area marking material is ejected during a pass, is called a swath. An image may be printed as an accumulation of swathes. Swathes that are subsequently printed on the receiving medium may overlap.

The image may be divided into strips, whereby a strip is defined as a part of the image that is printed as a non-overlapping part during a second pass of two consecutive passes. For each strip, an amount of marking material may be disposed on the receiving medium on an area having a width that equals a width of the paper step.

A print strategy for printing an image may be a multi-pass mode. For an integer n, a print strategy is called an n-pass mode, if ejecting marking material on an area of the receiving medium corresponding to a strip of the image is completed after n passes of the print head. According to such an n-pass mode, a part of the image that consists of n strips may be printed as a swath on the receiving medium. Such a swath is completed after 2n−1 passes of the print head.

For each strip, in a first pass, a first amount of marking material is ejected on the receiving medium, and in passes subsequent to the first pass, a remaining amount of marking material is ejected on the receiving medium. The first amount and the remaining amount per strip add up to the total amount of marking material required to print the strip on the receiving medium.

By printing the image, each strip is passed n times by the print head and, if there is a paper step between the passes, in each pass printing the strip another part of the nozzles of the print head are ejecting marking material on the same area on the receiving medium corresponding to the strip of the image.

Printing in passes may also be done by printing the whole image in a first number of passes, and after completing the first number of passes, reprinting the image in a second number of passes on the same place at the receiving medium.

When a reproduction apparatus is configured to print in a multi-pass mode out of at least two multi-pass modes, the reproduction apparatus may automatically select a multi-pass mode from the at least two multi-pass modes. The selected multi-pass mode may be optimal for the kind of image to be printed. On the other hand, the reproduction apparatus may have a user interface via which an operator may select a multi-pass mode he finds appropriate for printing the image. The appropriateness may depend on the kind of image or on wishes of the customer who orders the image to be printed according to a desired quality. Amongst others, such a quality aspect may be adhesion between the marking material and the receiving medium.

Adhesion between the marking material and the receiving medium is an important issue, especially when printing prints for display graphics applications. For many applications, the prints have to be post processed by cutting, folding or bending, for example. In order to prevent damaging the printed image, the adhesion between the marking material and the receiving medium has to be sufficient.

Since many different media types are used as receiving material for display graphics applications, it is very difficult to find a marking material formulation that has a good adhesion on all media with only inexpensive, non-toxic marking material components. One solution to improve adhesion is by directing heat, for example of a UV lamp, on a place on the receiving medium on which marking material is to be disposed. However, heat increase may have a severe impact on media handling reliability. Therefore, a reduction of heat output is desired.

### SUMMARY OF THE INVENTION

It is an object of the present invention to provide a method according to which the adhesion of the marking material and receiving medium is improved when printing according to a multi-pass mode.

According to the invention, this object is achieved by a method as described in the pre-amble wherein the method further comprises the step of determining the first amount based on a ratio between the first amount and the total amount of each strip.

The application is based on the concept that adhesion between marking material and receiving medium is mostly determined by the amount of marking material disposed in the first pass of each strip. The total amount of marking material needed for a strip to be printed is divided into a first amount in the first pass of the strip and a remaining amount in the subsequent passes of the strip.

The first amount is determined in such a way that the first amount is optimal for the adhesion of the marking material and the receiving medium. In addition, in the first pass of each strip, the corresponding first amount of marking material is ejected on the receiving medium. In any subsequent pass of the strip, the same first amount of marking material may also be ejected, but also another amount may be ejected in each of the passes subsequent to the first pass. The passes subsequent to the first pass are all the other passes of the strip. The remaining amount of the strip is the sum of amounts of marking material ejected in all the other passes of the strip. The first amount and the remaining amount per strip add up to the total amount of the strip.

In case of printing the image completely on the receiving medium and reprinting the image afterwards on the same place at the receiving medium, the first pass is the pass by which the first complete printing of the image is achieved and the first amount is the amount of marking material ejected during the first complete printing of the image. The subsequent passes may be the passes by which the image is reprinted after the first pass and the remaining amount is the amount of marking material ejected during reprinting the image. In the first pass, the image may be printed with only very small marking material drops, while larger drops may be ejected during the subsequent passes. This will result in a very light image on the receiving medium after the first pass. During the subsequent passes, the image may be reprinted on the same place on the receiving medium by means of a combination of small, middle and/or large marking material drops.

Research has revealed that an optimal adhesion is achieved by determining the first amount according to a specific ratio between the first amount of marking material ejected during the first pass of each strip and the total amount of marking material ejected during all the passes of the strip, wherein the ratio is equal for all multi-pass modes.

If the reproduction apparatus has at least one multi-pass mode, each mode is characterized by the number of passes that is needed to print each strip of the image, for example a 4-pass mode, a 6-pass mode or a 8-pass mode. The overlap of the swaths, each of which is printed during a pass, may vary from no overlap to an almost complete overlap of a width of a swath that is printed on the receiving material during one pass.

In an embodiment of the present invention, the method further comprises the steps of selecting a multi-pass mode out of at least two multi-pass modes and determining the first amount based on a ratio between the first amount and the total amount of each strip, which ratio is equal for the at least two multi-pass modes.

In an embodiment of the present invention, the reproduction apparatus is configured to activate a quality mode, and the method further comprising the steps of deciding whether or not to activate the quality mode, and determining the first amount based on a ratio between the first amount and the total amount of each strip, which ratio is determined by the decision in the deciding step.

The goal of the quality mode is to get an optimal adhesion between the marking material and the receiving medium. By activating the quality mode, the first amount in a first pass of each strip is determined in such a manner that a ratio between the first amount and the total amount of each strip is determined that deviates from a ratio between the first amount and the total amount of each strip, which ratio is used when the quality mode is not activated.

When activating the quality mode, the ratio is adapted to be optimal for adhesion between the marking material and the receiving medium.

In another embodiment of the method, the ratio is lying in a range from 5% to 20%. Experiments with UV curable inks have revealed that a ratio of the first amount and the total amount of UV curable ink in the range from 5% to 20% in a first pass of a 4-pass mode improves the adhesiveness between the UV curable ink ejected during printing of the image and the receiving medium. Other experiments have revealed that an improvement is also achieved, when applying a same ratio in a 6-pass mode or an 8-pass mode.

In another embodiment of the method, the ratio is approximately 12.5%. Experiments with UV curable ink have revealed that the use of this ratio of the first amount and the total amount leads to a further improvement of the adhesiveness of the marking material and the receiving medium.

The present invention also includes a reproduction apparatus comprising a print controller and a print engine comprising a print head with print elements for ejecting marking material on a receiving medium in order to print an image in a multi-pass mode and configured to activate a quality mode, said print controller being configured to select a multi-pass mode out of at least two multi-pass modes, divide the image into a plurality of strips, each strip requiring a total amount of marking material to be ejected on the receiving medium, and said print engine configured to eject for each strip a first amount of marking material on the receiving medium during a first pass of the strip and a remaining amount of marking material on the receiving medium during subsequent passes of the strip, wherein the print controller is configured to determine the first amount based on a ratio between the first amount and the total amount of each strip, which ratio is equal for the at least two multi-pass modes.

The present invention also relates to a reproduction apparatus comprising a print controller and a print engine comprising a print head with print elements for ejecting marking material on a receiving medium in order to print an image in a multi-pass mode, said print controller being configured to divide the image into a plurality of strips, each strip being a part of the image which is intended to be printed as a non-overlapping part during a second pass of two consecutive passes and requiring a total amount of marking material to be ejected on the receiving medium, and said print engine configured to eject for each strip a first amount of marking material on the receiving medium during a first pass of the strip and a remaining amount of marking material on the receiving medium during subsequent passes of the strip, wherein the print controller is configured to determine the first amount based on a ratio between the first amount and the total amount of each strip.

In an embodiment of the reproduction apparatus, the print controller is configured to select a multi-pass mode out of at least two multi-pass modes and to determine the first amount based on a ratio between the first amount and the total amount of each strip, which ratio is equal for the at least two multi-pass modes.

In an embodiment of the reproduction apparatus, the print controller is configured to decide whether or not to activate a quality mode and to determine the first amount based on a ratio between the first amount and the total amount of each strip, which ratio is determined by the decision whether or not to activate the quality mode.

The present invention also includes a computer program embodied on a non-transitory computer readable medium and comprising computer program code to enable a reproduction apparatus according to the present invention described hereinabove to execute the method according to any one of the embodiments described hereinabove.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1A illustrates an image forming apparatus to which the present invention is applicable;

FIG. 1B illustrates an ink jet printing assembly to be placed in the image forming apparatus of FIG. 1A;

FIG. 2 is a flow diagram of an embodiment of the method according to the present invention;

FIG. 3 is a flow diagram of an embodiment of a strip algorithm to be used when applying the method according to the present invention; and

FIG. 4 is a diagram showing the adhesion for different ratios of the first amount ejected during the first pass of the strip and the total amount of marking material ejected during all the passes of the same strip.

### DETAILED DESCRIPTION OF THE PREFERRED EMBODIMENTS

The present invention will now be described with reference to the accompanying drawings, wherein the same or similar elements are identified with the same reference numeral.

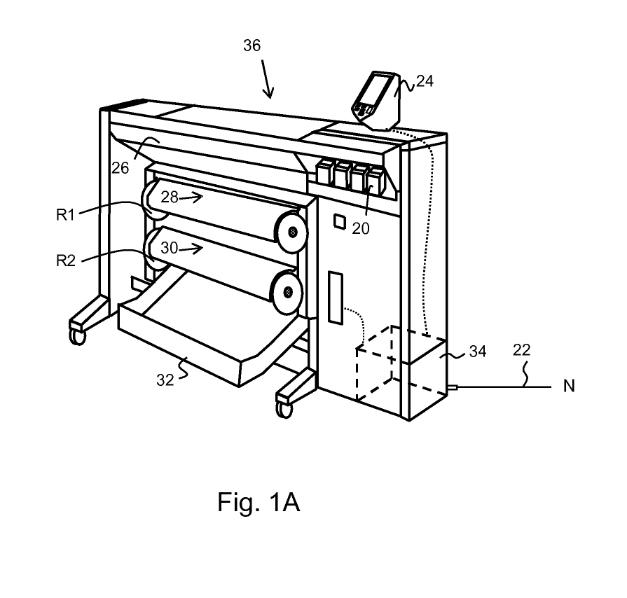

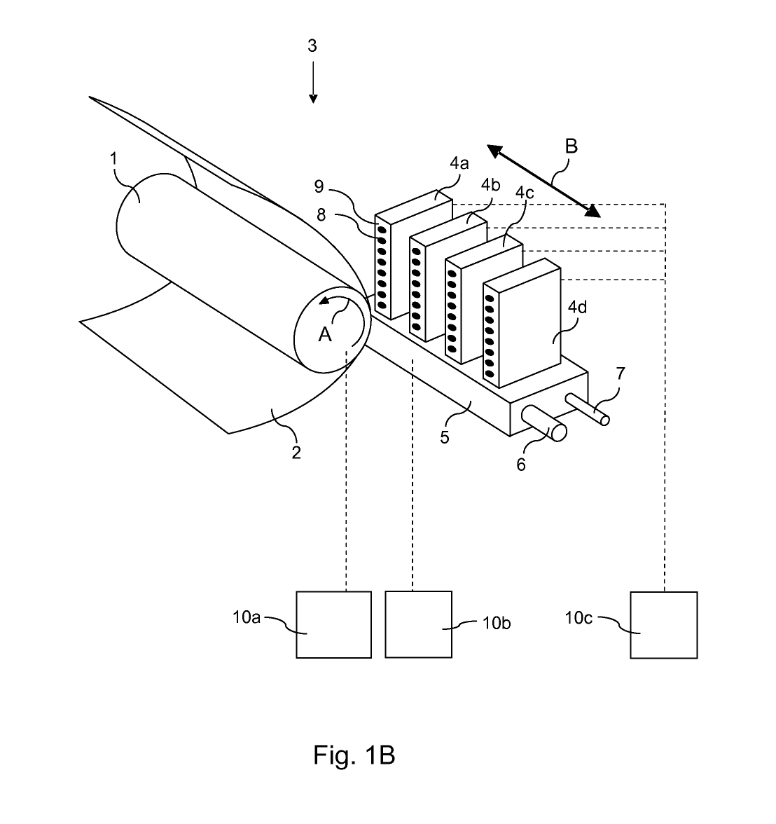

FIG. 1A illustrates an image forming apparatus 36, wherein printing is achieved using a wide format inkjet printer. The wide-format image forming apparatus 36 comprises a housing 26, wherein the printing assembly, for example the ink jet printing assembly shown in FIG. 1B is placed. The image forming apparatus 36 also comprises a storage device configured to store image receiving members, a delivery station to collect the image receiving members after printing and a storage device configured to mark material (containers 20). In FIG. 1A, the delivery station is embodied as a delivery tray 32. Optionally, the delivery station may comprise a processor configured to process the image receiving members after printing, e.g. a folder or a puncher. The wide-format image forming apparatus 36 furthermore comprises a device that is configured to receive print jobs and optionally a device configured to manipulate print jobs. These devices may include a user interface unit 24 and/or a control unit 34, for example a computer.

Images are printed on an image receiving member, for example paper, supplied by a roll 28, 30. The roll 28 is supported on the roll support R1, while the roll 30 is supported on the roll support R2. Alternatively, cut sheet image receiving members may be used instead of rolls 28, 30 of the image receiving members. Printed sheets of the image receiving members, cut off from the rolls 28, 30, are deposited in the delivery tray 32.

Each one of the marking materials for use in the printing assembly are stored in four containers 20 arranged in fluid connection with the respective print heads for supplying marking material to said print heads.

The local user interface unit 24 is integrated to the print engine and may comprise a display unit and a control panel. Alternatively, the control panel may be integrated in the display unit, for example in the form of a touch-screen control panel. The local user interface unit 24 is connected to a control unit 34 placed inside the image forming apparatus 36. In another embodiment, the local user interface unit 24 may comprise a selecting device configured to activate the quality mode as described in an embodiment of the method hereinabove.

The control unit 34, for example a computer, comprises a processor adapted to issue commands to the print engine, for example for controlling the print process. The image forming apparatus 36 may optionally be connected to a network N. The connection to the network N is diagrammatically shown in the form of a cable 22, but nevertheless, the connection could be wireless. The image forming apparatus 36 may receive printing jobs via the network. Further, optionally, the controller of the printer may be provided with a USB port, so printing jobs may be sent to the printer via this USB port. The control unit 34 may also be configured to automatically decide whether or not a quality mode is activated when printing an image.

FIG. 1B illustrates an ink jet printing assembly 3. The ink jet printing assembly 3 comprises a support configured to support an image receiving member 2. The support is shown in FIG. 1B as a platen 1, but alternatively, the support may be a flat surface. The platen 1, as depicted in FIG. 1B, is a rotatable drum, which is rotatable about its axis as indicated by arrow A. The support may optionally be provided with suction holes for holding the image receiving member 2 in a fixed position with respect to the support. The ink jet printing assembly 3 comprises print heads 4a-4d, mounted on a scanning print carriage 5. The scanning print carriage 5 is guided by suitable guides 6, 7 to move in reciprocation in the main scanning direction B. Each print head 4a-4d comprises an orifice surface 9, which orifice surface 9 is provided with at least one orifice 8. The print heads 4a-4d are configured to eject droplets of marking material onto the image receiving member 2. The platen 1, the carriage 5 and the print heads 4a-4d are controlled by suitable control units 10a, 10b and 10c, respectively.

The image receiving member 2 may be a medium in web or in sheet form and may be composed of, e.g. paper, cardboard, label stock, coated paper, plastic or textile. Alternatively, the image receiving member 2 may also be an intermediate member, endless or not. Examples of endless members, which may be moved cyclically, are a belt or a drum. The image receiving member 2 is moved in the sub-scanning direction A by the platen 1 along four print heads 4a-4d provided with a fluid marking material.

A scanning print carriage 5 carries the four print heads 4a-4d and may be moved in reciprocation in the main scanning direction B parallel to the platen 1, such as to enable scanning of the image receiving member 2 in the main scanning direction B. Only four print heads 4a-4d are depicted for demonstrating the present invention. In practice, an arbitrary number of print heads may be employed. In any case, at least one print head 4a-4d per color of marking material is placed on the scanning print carriage 5. For example, for a black-and-white printer, at least one print head 4a-4d, usually containing black marking material is present. Alternatively, a black-and-white printer may comprise a white marking material, which is to be applied on a black image-receiving member 2. For a full-color printer, containing multiple colors, at least one print head 4a-4d for each of the colors, usually black, cyan, magenta and yellow is present. Often, in a full-color printer, black marking material is used more frequently in comparison to differently colored marking material. Therefore, more print heads 4a-4d containing black marking material may be provided on the scanning print carriage 5 compared to print heads 4a-4d containing marking material in any of the other colors. Alternatively, the print head 4a-4d containing black marking material may be larger than any of the print heads 4a-4d, containing a differently colored marking material.

The carriage 5 is guided by guides 6, 7. The guides 6, 7 may be rods as depicted in FIG. 1B. The rods may be driven by a suitable drive (not shown). Alternatively, the carriage 5 may be guided by other guides, such as an arm being able to move the carriage 5. Another alternative is to move the image receiving material 2 in the main scanning direction B.

Each print head 4a-4d comprises an orifice surface 9 having at least one orifice 8, in fluid communication with a pressure chamber containing fluid marking material provided in the print head 4a-4d. On the orifice surface 9, a number of orifices 8 is arranged in a single linear array parallel to the sub-scanning direction A. Eight orifices 8 per print head 4a-4d are depicted in FIG. 1B, however obviously in a practical embodiment several hundreds of orifices 8 may be provided per print head 4a-4d, optionally arranged in multiple arrays. As depicted in FIG. 1B, the respective print heads 4a-4d are placed parallel to each other such that corresponding orifices 8 of the respective print heads 4a-4d are positioned in-line in the main scanning direction B. This means that a line of image dots in the main scanning direction B may be formed by selectively activating up to four orifices 8, each of them being part of a different print head 4a-4d. This parallel positioning of the print heads 4a-4d with corresponding in-line placement of the orifices 8 is advantageous to increase productivity and/or improve print quality. Alternatively, multiple print heads 4a-4d may be placed on the print carriage adjacent to each other such that the orifices 8 of the respective print heads 4a-4d are positioned in a staggered configuration instead of in-line. For instance, this may be done to increase the print resolution or to enlarge the effective print area, which may be addressed in a single scan in the main scanning direction. The image dots are formed by ejecting droplets of marking material from the orifices 8.

Upon ejection of the marking material, some marking material may be spilled and stay on the orifice surface 9 of the print head 4a-4d. The ink present on the orifice surface 9, may negatively influence the ejection of droplets and the placement of these droplets on the image receiving member 2. Therefore, it may be advantageous to remove excess ink from the orifice surface 9. The excess of ink may be removed, for example by wiping with a wiper and/or by application of a suitable anti-wetting property of the surface, e.g. provided by a coating.

The method of the present invention is applied in an inkjet printer according to FIG. 1A comprising a print head according to FIG. 1B. A marking material may be a UV curable ink. The receiving medium may be paper, corrugated plastic such as COROPLAST®, plastic sheets such as GATORPLAST®, polycarbonate, scrim banner, or polystyrene (even black polystyrene). In general, the amount of marking material disposed in the first pass of each strip is substantially independent of the type of receiving medium.

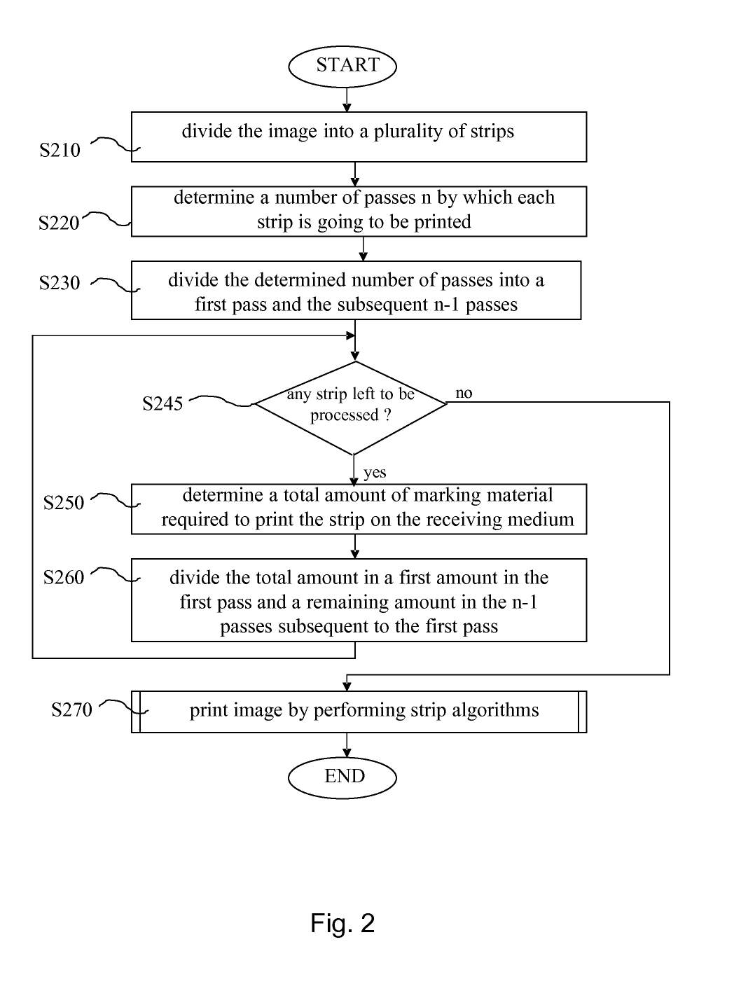

FIG. 2 is a flow diagram of an embodiment of the method according to the present invention.

In a first step S210, the image to be printed is divided into a plurality of strips according to the formulated definition of a strip hereinabove.

In a second step S220, a multi-pass mode is selected out of the at least two multi-pass modes. The selection of the multi-pass mode may be automatically by the control unit of the reproduction apparatus or manually via the local user interface of the reproduction apparatus or even via manually selecting an option in a driver mechanism by which the image is sent to the reproduction apparatus. The selection of the multi-pass mode determines the number of passes by which each strip is going to be printed. Each multi-pass mode of the reproduction apparatus corresponds to a number of passes by which each strip is going to be printed. For example, a 4-pass, a 6-pass and an 8-pass mode corresponds to, respectively 4 passes per strip, 6 passes per strip and 8 passes per strip.

In a third step S230, the number of passes is divided into the first pass and the subsequent passes. For example, for a 4-pass mode, the number of subsequent passes is 3, for a 6-pass mode, the number of subsequent passes is 5 and for a 8-pass mode, the number of subsequent passes is 7.

In the next steps S245, S250, S260, each strip of the image is processed.

After processing a strip, it is checked in a decision step S245 if there is any strip left to be processed. If not, the method continues with a print step S270 to print the image by applying strip algorithms.

If so, in a next step S250 for the strip under processing, the total amount of marking material is determined, which is required to print the strip on the receiving medium. This amount may be calculated from pixel data information of the image. In an embodiment of the method concerning printing of a multi-color image, the total amount of step S250 may be determined per needed color.

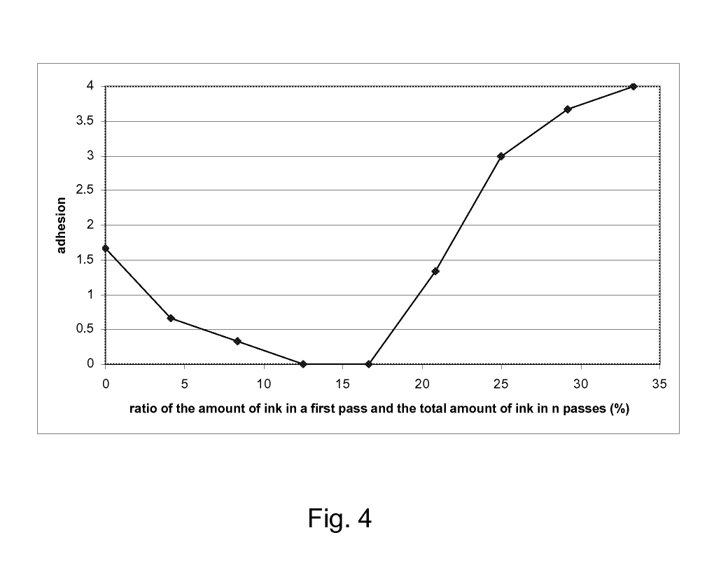

In a next step S260, the total amount is divided in a first amount in the first pass of the strip under processing and an amount in each of the subsequent passes of the strip under processing. The ratio of the first amount with respect to the total amount is the determined ratio according to experiments of the inventors. The first amount ratio is the same for all multi-pass modes. In other words, it does not matter which multi-pass is selected in the second step S220, the ratio is constant. As is shown in FIG. 4, very good results for the adhesion of receiving medium and marking material is achieved for a first amount ratio of 12.5%, while a first amount ratio of a range from 5 to 20% give also good results. Since the first amount in the first pass of the strip and the total amount in all passes of the strip are determined, also the remaining amount for the subsequent passes of the strip is determined. This remaining amount may be equally distributed among the subsequent passes, but may also be distributed according to other distribution methods.

In another embodiment, a division of the total amount in the first amount and the remaining amount is executed by dividing the pixels of the image into a first amount of pixels of the image and the remaining amount of pixels of the image in the same ratio, wherein the first amount of pixels are printed in the first pass of the strip while the remaining amount of pixels are printed in the passes subsequent to the first pass. The division of the pixels may be controlled by a print mask or any other measure by the print controller.

When all strips have been processed under steps S245, S250 and S260, the print step S270 is executed. In this step S270, the image is printed by performing a plurality of similar strip algorithms. For each strip there is one strip algorithm.

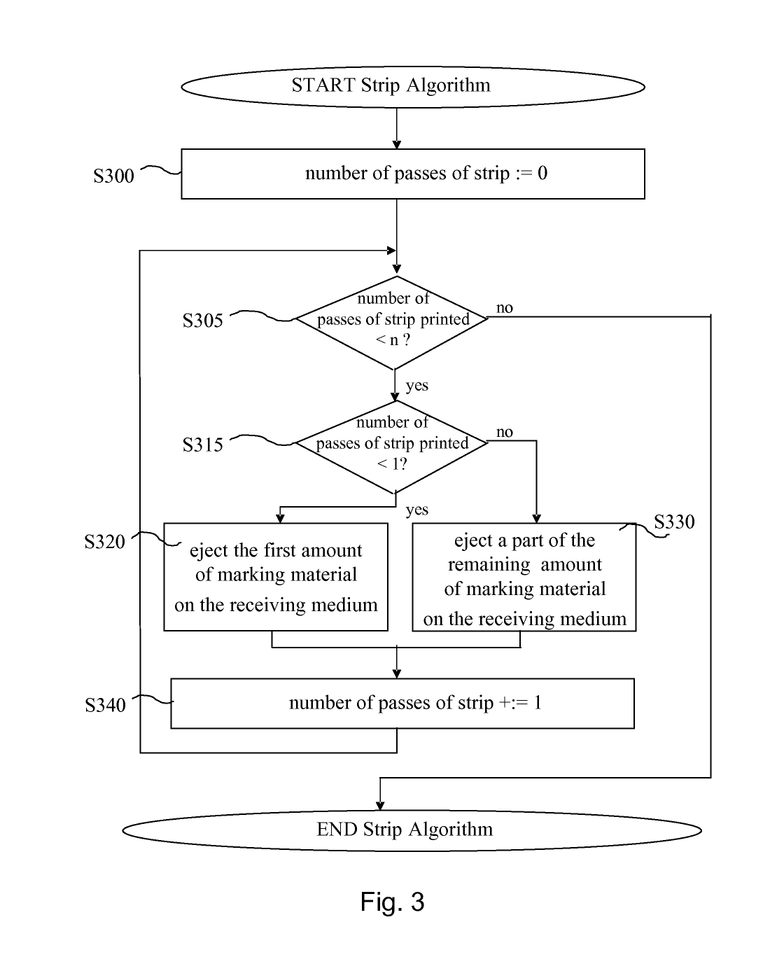

An embodiment of a strip algorithm is shown in FIG. 3 using an n-pass mode of the reproduction apparatus. In a first setting step S300 of the strip algorithm, the number of passes of the strip is set to zero.

In a first decision step S305 of the strip algorithm, it is checked if the number of passes of the strip under processing is less than n. If not, the strip is completely printed and the strip algorithm has ended for the strip under processing. If so, the algorithm proceeds to a second decision step S315.

In the second decision step S315, it is checked if the number of passes of the strip is less than 1. If so, the algorithm proceeds to a first ejection step S320.

In the first ejection step S320, the first amount of marking material determined for the strip and the first pass is ejected on the receiving medium during the first pass.

If not, the algorithm proceeds to a second ejection step S330.

In the second ejection step S330, a part of the remaining amount of marking material determined for the strip and the intended subsequent pass is ejected on the receiving medium during the same subsequent pass. The parts of the remaining amount ejected during all subsequent passes to the first pass in the second ejection steps S330 and the first amount ejected in the first ejection step S320 add up to the total amount of marking material for the strip under processing.

When either the first ejection step S320 or the second ejection step S330 has been completed, the algorithm proceeds with a second setting step S340 in which the number of passes of the strip is incremented by one. After the second setting step S340, the algorithm returns to the first decision step S305.

In an advantageous embodiment, the strip algorithms are executed in parallel. Moreover, in an embodiment, corresponding steps S305, S315, S320, S330 of different strips, e.g. neighboring strips of the image, are sequenced if the print head is printing more than one strip in the same pass. This principle will be explained below on the basis of a 4-pass mode. The principle may also be applied in other n-pass print strategies.

In another advantageous embodiment, the strip algorithms described in FIG. 3 are integrated in the flow diagram of FIG. 2. In this way, the calculations of the amount of marking material per pass of a strip may take place in parallel with the ejection of an already calculated amount of marking material for another strip. By doing so, the productivity of the reproduction apparatus will increase.

In another advantageous embodiment, the method comprises an additional step of activating a quality mode. In the previous embodiments, the reproduction apparatus was automatically applying the ratio between the first amount and the total amount according to the present invention. In this embodiment, the reproduction apparatus has an extra quality mode embodied in the print controller by means of a lookup table or a dedicated part of a memory of the print controller. The quality mode may be activated by means of the local user interface before printing the image. When activating the quality mode, the ratio between the first amount and the total amount determined in the previous methods are used. When no activation of the quality mode takes place, ratios as initially configured for the reproduction apparatus are used.

According to an embodiment, a 4-pass mode is applied. The first amount of each strip is 12.5% of the total amount of the strip, while each part of the remaining amount of each strip are approximately 29.1% of the total amount of the strip. The image is divided in a number of strips, for example 4 strips s1, s2, s3, s4. The total amount of marking material to be ejected per strip is according to the image determined to be respectively t1, t2, t3, t4. The print head can simultaneously eject marking material on four consecutive strips in one pass of the print head. Between the passes, a paper step of a width of an area on the receiving medium corresponding to a printed strip of the image occurs. Then, the following scenario is implemented. The strip algorithm for each strip s1, s2, s3, s4 is started and for each strip s1, s2, s3, s4, the number of passes is set to zero in the first setting step S300. The strip algorithms for the second strip s2, the third strip s3 and the fourth strip s4 are put on hold. The strip algorithm of the first strip s1 proceeds with the decision steps S305, S315 and proceeds with the first ejection step S320. An amount of marking material of 0.125*t1 is ejected on an area of the receiving medium corresponding with the first strip t1. In the second setting step S340, the number of passes of the first strip s1 is incremented by one. Now the strip algorithm for strip s2 is activated again and simultaneously executed with the strip algorithm of strip s1. The strip algorithms of the first strip s1 and the second strip s2 proceed with the decision steps S305, S315. According to the decisions in the decision steps S305, S315, the strip algorithm of the first strip s1 proceeds with a second ejection step S330, while simultaneously, the strip algorithm of the second strip s2 proceeds with first ejection step S320. The ejection of marking material on the areas corresponding with the respective first strip s 1 and second strips s2 takes place simultaneously during a pass, which is the second pass of the first strip s1 and the first pass of the second strip s2. The amount of marking material ejected on the area corresponding with the first strip s1 is 0.291*t1, while the amount of marking material ejected on the area corresponding with the second strip s1 is 0.125*t2. Continuing in this way, the image of the four strips s1, s2, s3, s4 will be printed according to Table 1.

TABLE 1

| | | | | | | | |
|---|---|---|---|---|---|---|---|
| | 1^{st} pass | 2^{nd} pass | 3^{rd} pass | 4^{th} pass | | | |
| | strip s1 | strip s1 | strip s1 | strip s1 | | | |
| | | 1^{st} pass | 2^{nd} pass | 3^{rd} pass | 4^{th} pass | | |
| | | strip s2 | strip s2 | strip s2 | strip s2 | | |
| | | | 1^{st} pass | 2^{nd} pass | 3^{rd} pass | 4^{th} pass | |
| | | | strip s3 | strip s3 | strip s3 | strip s3 | |
| | | | | 1^{st} pass | 2^{nd} pass | 3^{rd} pass | 4^{th} pass |
| | | | | strip s4 | strip s4 | strip s4 | strip s4 |
| Amounts | | | | | | | |
| Strip s1 | 0.125*t1 | 0.291*t1 | 0.291*t1 | 0.291*t1 | | | |
| Strip s2 | | 0.125*t2 | 0.291*t2 | 0.291*t2 | 0.291*t2 | | |
| Strip s3 | | | 0.125*t3 | 0.291*t3 | 0.291*t3 | 0.291*t3 | |
| Strip s4 | | | | 0.125*t4 | 0.291*t4 | 0.291*t4 | 0.291*t4 |

According to the present invention, the first amount mentioned in the first ejection step S320 and the part of the remaining amount mentioned in the second ejection step S330 may differ per strip per pass. Moreover, the three parts of the remaining amount to be ejected in respectively a second, a third and a fourth pass of each strip may differ. In an embodiment of the method, the ratios for the 4-pass mode are (0.125, 0.25, 0.25, 0.375) in the consecutive passes instead of the ratios (0.125, 0.291, 0.291, 0.291) according to Table 1. In exceptional cases, a pass may eject a very small amount of or no marking material for a strip, for example the ratios for the 4-pass mode may be (0.125, 0.05, 0.4, 0.425) in the consecutive passes.

FIG. 4 is a diagram showing the adhesion for different ratios of amounts of marking material ejected during the first pass of each strip. The results measured for the adhesion as shown in FIG. 4 are achieved by printing the image by an inkjet printer according to a 6-pass mode and by varying the ratios of the first amount of ink in the first pass for each strip. The results shown in FIG. 4 are averaged on the basis of a plurality of observations.

The adhesion is measured for ratios of amounts of ink in the first pass of 0.0, 4.2, 8.3, 12.5, 16.7, 20.8, 25.0, 29.2 and 33.3. The results of the adhesion is displayed on a linear scale from 0 (very good adhesion) to 4 (very bad adhesion) according to ISO 2409, which is used for determination of the adhesion of lacquer on a base by means of a cross-cut test. For the range of ratios from 5 to 20% good adhesion results have been measured. In particular, for the ratio 12.5 as well as for the ratio 16.7 very good adhesion results have been measured.

The measures are repeated for 4-pass mode and 8-pass mode. The ratios of the first amounts for each of these repeating measures that are optimal for adhesion are shown in Table 2.

TABLE 2

| n-pass mode | 4-pass | 6-pass | 8-pass |
|---|---|---|---|
| Pass 1 | 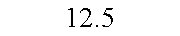 | 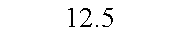 | 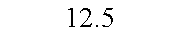 |
| Pass 2 | 29.2 | 12.5 | 12.5 |
| Pass 3 | 29.2 | 12.5 | 12.5 |
| Pass 4 | 29.2 | 20.8 | 12.5 |
| Pass 5 | | 20.8 | 12.5 |
| Pass 6 | | 20.8 | 12.5 |
| Pass 7 | | | 12.5 |
| Pass 8 | | | 12.5 |
| Total | 100.0 | 100.0 | 100.0 |

Table 2 is showing the optimal ratios of amounts of marking material ejected during each pass of a strip during one of the experiments. An amount ejected during the first pass of the strip is presented in a grey-shaded cell, while an amount ejected during a pass of the subsequent passes of the strip is presented in a cell with a white background. The marking material used in this experiment is a UV curable ink.

In the 4-pass mode the printing of the image is realised by overlapping swathes of ¼ of the swath width. The first amount in the first pass of each strip is 12.5% of the total amount of ink to be ejected during printing the image part corresponding to the strip, while the amount per pass of the remaining passes of the strip is 29.2% of the total amount of ink to be ejected during printing the image part corresponding to the strip.

In the 6-pass mode the printing of the image is realised by overlapping swathes of ⅙ of the swath width. The amount of the first three passes of each strip is again 12.5% of the total amount of ink to be ejected during printing the image part corresponding to the strip, while the amount per pass of the remaining passes of the strip is 20.8% of the total amount of ink to be ejected during printing the image part corresponding to the strip.

In the 8-pass mode the printing of the image is realised by overlapping swathes of ⅛ of the swath width. The amount in the first four passes of each strip is again 12.5% of the total amount of ink to be ejected during printing of the image part corresponding to the strip, while the amount per pass of the remaining passes of the strip is also 12.5% of the total amount of ink to be ejected during printing of the image part corresponding to the strip.

Table 2 shows that a first amount of ink ejected during the first pass of each strip of 12.5% of the total amount determined for the strip is optimal for adhesion for all multi-pass modes.

In practice, this conclusion leads to an implementation of a multi-pass mode in which a ratio of such a first amount and corresponding total amount is determined to be approximately 12.5% independently of the selected multi-pass mode according to the method of the present invention. FIG. 4 also shows that good results are achieved when determining the ratio of the first amount and the total amount from a range of 5% to 20%.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for printing an image with a reproduction apparatus, the reproduction apparatus including a print head with print elements for ejecting marking material on a receiving medium in a multi-pass mode, said method comprising the steps of:
a) selecting a multi-pass mode out of at least two multi-pass modes;
b) dividing the image into a plurality of strips, each of said plurality of strips being a part of the image that is intended to be printed as a non-overlapping part during a second pass of two consecutive passes and requiring a total amount of marking material to be ejected on the receiving medium;
c) ejecting for each strip a first amount of the total amount of marking material on the receiving medium during a first pass;
d) ejecting for each strip a remaining amount of the total amount of marking material on the receiving medium during passes subsequent to the first pass; and
e) determining the first amount based on a ratio between the first amount and the total amount of each strip, the ratio being equal for the at least two multi-pass modes.

2. The method according to claim 1, wherein the reproduction apparatus is configured to activate a quality mode, said method further comprising the steps of:
f) deciding whether or not to activate the quality mode; and
g) determining the first amount based on a ratio between the first amount and the total amount of each strip, the ratio being determined by the step of deciding in step f).

3. The method according to claim 1, wherein the ratio is within a range of from 5% to 20 %.

4. The method according to claim 3, wherein the ratio is approximately 12.5%.

5. The method according to claim 1, further comprising the step of printing the image with UV curable ink.

6. A reproduction apparatus, comprising:
a print controller; and
a print engine including a print head with print elements for ejecting marking material on a receiving medium in order to print an image in a multi-pass mode,
wherein said print controller is configured to select a multi-pass mode out of at least two multi-pass modes and divide the image into a plurality of strips, each of the plurality of strips being a part of the image that is intended to be printed as a non-overlapping part during a second pass of two consecutive passes and requiring a total amount of marking material to be ejected on the receiving medium,
wherein said print engine is configured to eject for each of the plurality of strips a first amount of marking material on the receiving medium during a first pass of the strip and a remaining amount of marking material on the receiving medium during subsequent passes of the strip, and
wherein the print controller is configured to determine the first amount based on a ratio between the first amount and the total amount of each strip, the ratio being equal for the at least two multi-pass modes.

7. The reproduction apparatus according to claim 6, wherein the print controller is configured to decide whether or not to activate a quality mode and to determine the first amount based on a ratio between the first amount and the total amount of each strip, the ratio being determined by the decision whether or not to activate the quality mode.

8. A computer program embodied on a non-transitory computer readable medium and comprising computer program code to enable the reproduction apparatus according to claim 6 to execute a method for printing an image with the reproduction apparatus, the method comprising the steps of:
a) selecting a multi-pass mode out of at least two multi-pass modes;
b) dividing the image into a plurality of strips, each of said plurality of strips being a part of the image that is intended to be printed as a non-overlapping part during a second pass of two consecutive passes and requiring a total amount of marking material to be ejected on the receiving medium;
c) ejecting for each strip a first amount of the total amount of marking material on the receiving medium during a first pass;
d) ejecting for each strip a remaining amount of the total amount of marking material on the receiving medium during passes subsequent to the first pass; and
e) determining the first amount based on a ratio between the first amount and the total amount of each strip, the ratio being equal for the at least two multi-pass modes.
